(19) United States
(12) Patent Application Publication
(10) Pub. No.: US 2015/0029718 A1
(43) Pub. Date: Jan. 29, 2015

(54) DIFFUSE LAMP

(71) Applicant: Grain Lighting, Inc., Oakland, CA (US)

(72) Inventors: Robert Cook, Oakland, CA (US); Vishal Talwar, Oakland, CA (US); Marc Lander, Oakland, CA (US); Derek Fukumori, Oakland, CA (US)

(21) Appl. No.: 14/444,852

(22) Filed: Jul. 28, 2014

Related U.S. Application Data
(60) Provisional application No. 61/859,083, filed on Jul. 26, 2013.

(51) Int. Cl. F21K 99/00; F21V 9/16

(52) U.S. Cl. CPC F21K 9/50; F21V 9/16; F21Y 2101/02
USPC 362/235

(57) ABSTRACT

A lighting assembly including an array of light emitting diodes mounted along a first face of a substrate, a curved translucent diffuser retained proximal the first face of the substrate, offset from the substrate a first distance, a light-absorbing mask including an array of light-transparent windows, the light-absorbing mask arranged between the substrate and the diffuser and retained offset from the first face of the substrate a second distance, with the light-transparent windows substantially aligned with the array of light emitting diodes, and a thermally insulative casing mounted to a second face of the substrate opposing the first face of the substrate.

### CROSS-REFERENCE TO RELATED APPLICATIONS

This application claims the benefit of U.S. Provisional Application No. 61/859,083 filed 26 Jul. 2013, which is incorporated in its entirety by this reference.

### TECHNICAL FIELD

This invention relates generally to the lighting field, and more specifically to a new and useful diffuse lamp in the lighting field.

### BACKGROUND

When selecting a light for a space, there is oftentimes a desire for a light that simultaneously illuminates the given space and displays a dynamically moving image. For example, there is oftentimes a desire for lighting that mimics naturally occurring, shifting light patterns.

However, both conventional lights and monitors fail to fulfill this need. Conventional lights typically only display one perceived light color, are not dynamic, and are generally incapable of displaying representational imagery. Monitors, while capable of displaying representational imagery, are incapable of functioning as lights. First, monitors do not provide the illumination required to adequately light a space. Second, because monitors are meant to be viewed and not meant to light a room, the light quality provided by monitors is poor. More specifically, monitors only emit red, green, and blue light frequencies, which, while adequate for viewing, result in poor light reflection. This causes the objects in the space that are illuminated by the light to look flat or lackluster. Furthermore, monitors are generally very expensive due to the high density of light emitting elements required to achieve monitor-grade resolution, and using monitors as lighting sources is simply not economically feasible.

Thus, there is a need in the lighting field to create a new and useful active light that is cost effective and illuminates a space with a dynamically changing representational image. This invention provides such new and useful active light.

### BRIEF DESCRIPTION OF THE FIGURES

FIG. 1 is a perspective view of a variation of the lighting system.

FIGS. 2 and 3 are an exploded perspective view and an exploded side view of a variation of the lighting system, respectively.

FIGS. 4 and 5 are schematic representations of a first and a second example of light emitting element projection patterns on the diffuser, respectively.

FIG. 6 is a side view of a variation of an assembled lighting system.

FIG. 7 is a schematic representation of a shaping mask trimming the emission cone of a light emitting element.

FIG. 8 is a schematic representation of a first and second lighting system coupled together in an array.

FIGS. 9A and 9B are schematic representations of a first and second variation of a diffuser cross-sections, respectively.

FIG. 10 is an example of a representational image displayed by the lighting system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

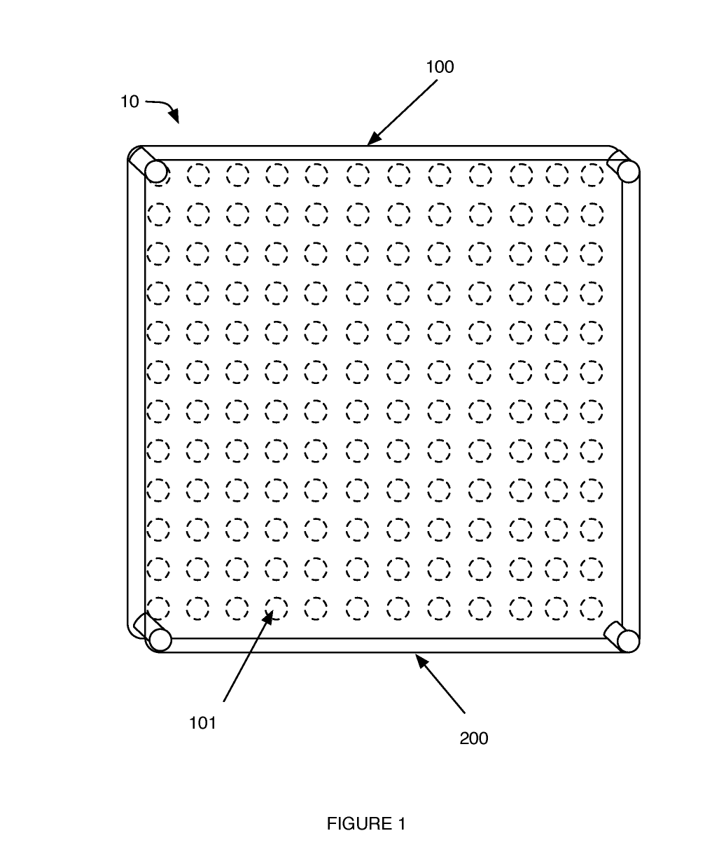

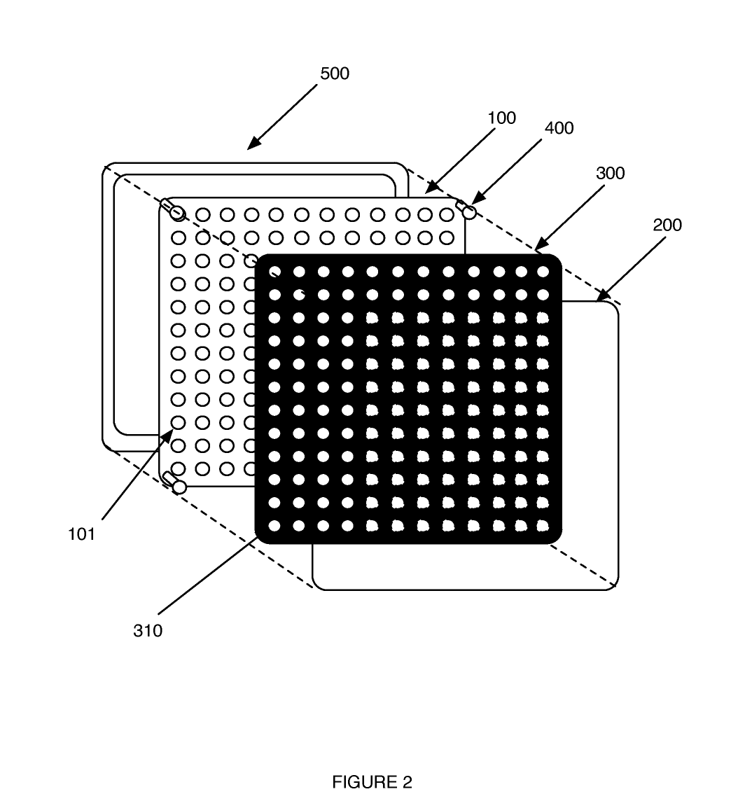

As shown in FIGS. 1, 2, and 3, the lighting system 10 includes a light emitting arrangement 100, a diffuser 200, and an absorbing mask 300. The lighting system functions to illuminate a space with light that is used to display a representational image. More preferably, the lighting system illuminates a space with light that renders a dynamically moving image. This lighting system functions to achieve the resolution and contrast required to render the representational imagery while producing the luminous intensity required to light a given space. The lighting system configuration functions to achieve these parameters with a minimal number of light emitting elements. The lighting system is preferably for indoor use, but can alternatively be for outdoor use. The lighting system can be prismatic, cylindrical, conical, frustroconical, spherical, amorphous, or have any other suitable shape. Light is preferably emitted from a broad face of the lighting system (e.g., a broad planar face or an arcuate surface), but can alternatively be emitted from a minor face of the lighting system (e.g., an end of the cylinder, etc.).

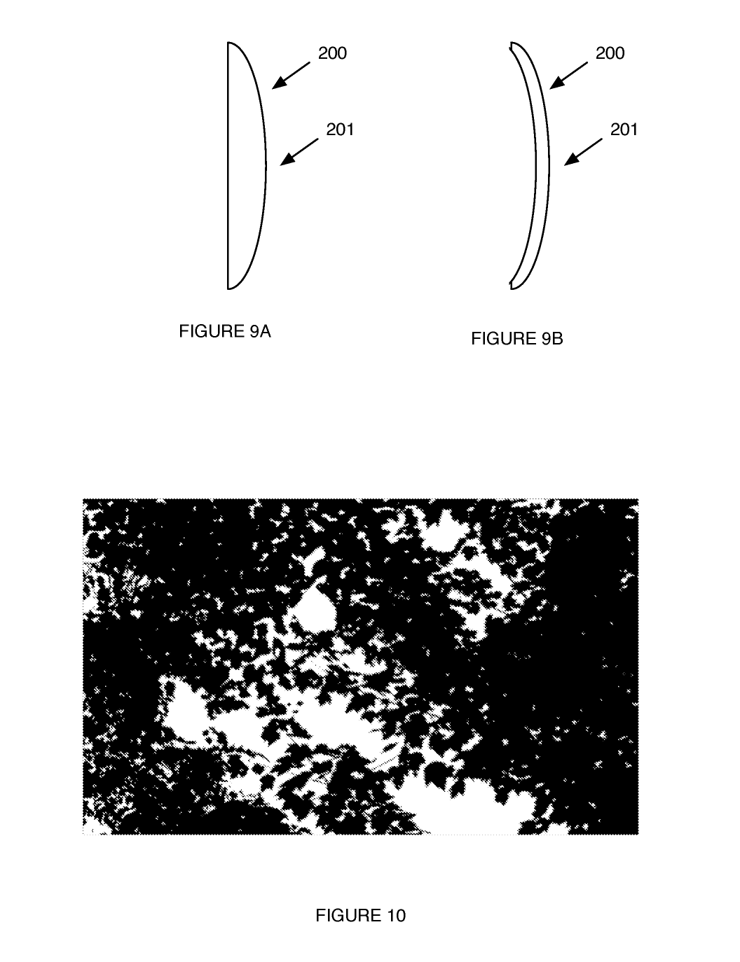

Conventionally, the space that is to be illuminated dictates the properties of the light that is selected. However, the inventors have discovered that a lighting system can shape a space by illuminating the space using light from a diffuse image. This representational imagery is preferably of recognizable shapes, such as human forms, flames, clouds, and dappled sunlight shining through trees (such as that shown in FIG. 10). However, the rendered imagery can be of abstract or nonrepresentational images, which are not derived from real figures or objects.

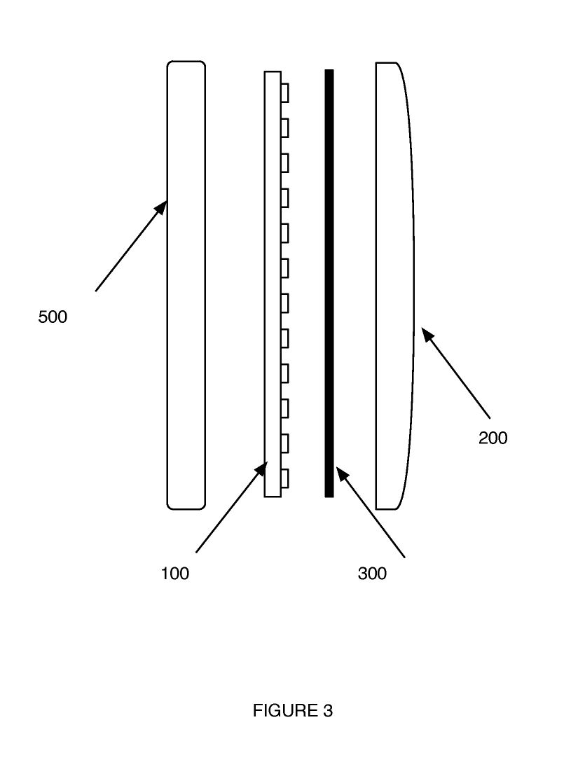

In order to display a representational image, the lamp must have suitable resolution and contrast. In order to obtain both these parameters, the lamp is preferably arranged such that the light emitting element projections 102 on the diffuser overlap to cover the entire active area of lamp. The lamp is more preferably configured such that the projection overlap of adjacent light emitting elements is minimized. The light emitting element projections preferably overlap between 10% and 30% but can alternatively overlap between 10% and 20%, 20% and 30%, or have any other suitable amount of overlap. For example, when the lighting system has a rectilinear arrangement of light emitting elements, the projections of diagonally arranged light emitting elements preferably touch but do not substantially overlap, as shown in FIG. 4. In another example, when the lighting system has a regular hexagonal arrangement of light emitting elements, the projections of adjacent light emitting elements preferably overlap adjacent light emitting element projections, as shown in FIG. 5. This light emitting element projection arrangement produces the contrast and effective resolution required to represent recognizable images while simultaneously minimizing the number of light emitting elements required to do so.

This lighting system 10 functions to convey low-resolution imagery in way that can be interpreted by the human vision system. Low resolution computer images typically have a blockiness to them—the composite pixels are squares that only resolve into something more organic at higher resolutions or at greater viewing distances (e.g., wherein the pixels appear to be smaller than a particular threshold of the viewer's field of vision). One reason for this is that for any particular image, a minimum amount of information (number of total pixels) is required to render a recognizable image. Furthermore, the square pixels themselves are recognized as edges and vertices by the human visual system. These non-informational features are emphasized at the expense of the pixels themselves, and interfere with the actual information to render imagery formed from large pixels difficult to interpret. By rendering circular, soft-edged, and overlapping pixels, the distracting edges and vertices of conventional pixels are removed, allowing users to recognize the image at much lower resolutions.

As shown in FIGS. 1, 2, and 3, the light emitting arrangement 100 of the lighting system functions to emit light and to render the representational image. The light emitting arrangement is preferably controlled by a processing unit, which controls the light emitting elements of the light emitting arrangement to collectively display an image. The processing unit can receive image data from a sensor (e.g., camera sensor, temperature sensor, etc.), from a storage unit (e.g., on-board memory), from a network (e.g., the internet), or from any other suitable data source. The light emitting arrangement is preferably electrically connectable to and powered by a power supply, wherein the power supply can be an on-board, rechargeable power supply, a substantially stationary power supply (e.g., a wall outlet), or any other suitable power supply.

The light emitting arrangement is preferably formed from a plurality of light emitting elements 110. The light emitting element is preferably an LED (light emitting diode), but can alternatively be any other suitable element that emits light. The LED is preferably a tri-color LED, more preferably an RGB LED, but can alternatively be a white LED (e.g., warm white LED, formed from a phosphor-coated blue LED), a deep red LED, a bi-color LED, or any other suitable LED. The LEDs are preferably low-power LEDs, but can alternatively be mid-range LEDs or high-power LEDs. The light emitting arrangement is preferably formed from the same type of light emitting element, but can alternatively include a combination of multiple light emitting element types.

The light emitting arrangement preferably includes a regular arrangement of pixels 101 (e.g., an array), but can alternatively include an irregular pixel arrangement. The pixels can be arranged in a regular rectangular pattern (e.g., in a square pattern), a regular hexagonal pattern, a radial pattern (e.g., arranged along rays extending from a central point or pixel), a repeating circular pattern, a concentric pattern, a sinusoidal pattern, or any other suitable radial pattern. Alternatively, the light emitting arrangement can be an irregular arrangement, an arrangement with the light emitting elements concentrated in the center of the lamp and decreasing in density with radial distance away from the center, or have any other suitable pattern.

The density of the light emitting elements within the arrangement is preferably 1 pixel per square inch, but can alternatively be higher or lower. The density of the light emitting elements preferably varies inversely with the distance between the light emitting elements and the diffuser, but can alternatively vary proportionally with the distance.

Each pixel of the light emitting arrangement is preferably formed from one light emitting element. Alternatively, multiple light emitting elements can be clustered to form a pixel. The multiple light emitting elements of a cluster preferably each emit different frequencies of light, but can alternatively emit the same frequencies of light. The multiple light emitting elements of a cluster are preferably the same type of light emitting elements (e.g., all LEDs), but can alternatively be different types of light emitting elements. For example, a pixel can include a single RGB LED, a single white LED, a single deep red LED, and/or any suitable combination of the RGB, white, and deep red LEDs. However, different types of light emitting elements can be arranged serially (e.g., in a row), arranged at different positions of the light emitting arrangement patterns, or arranged in any other suitable configuration.

The light emitting elements are preferably electrically connected to (e.g., mounted on) a substrate 120. The substrate functions to support the light emitting elements, and can additionally function to provide power and control data to the light emitting elements. An example of the substrate includes a PCB. The substrate is preferably substantially planar, such that the light emitting elements share a common plane. However, the substrate can be curved, wavy, include through-holes between light emitting element mounting points, or have any other suitable configuration.

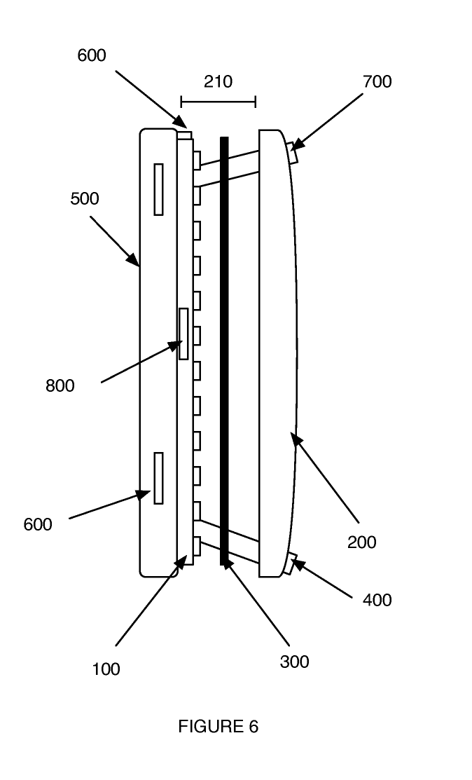

As shown in FIG. 7, each light emitting element preferably emits light in an emission cone, which broadens with distance from the light emitting element. The emission cone is preferably a 60° cone, but can alternatively be an 80° cone, be larger (e.g., 180°, 90°, etc.), or be smaller than 60°. This emission cone can be occluded by a system element, such as the matting (e.g., absorbing mask) or an auxiliary mask. The occluding element can reduce the angular coverage of the original emission cone 111 to a trimmed emission cone 112, redirect the emission cone, or otherwise shape or adjust the emission cone. For example, the occluding element can reduce the emission cone to a 90° cone, a 60° cone, or a cone of any other suitable emission angle. Cone occlusion functions to adjust the diameter of the light emitting element projection on the diffuser, and can be tailored to adjust the amount of adjacent light emitting element projection overlap, thereby adjusting the contrast and resolution of the lighting system. Cone occlusion can additionally function to collimate the light emitted by the light emitting element. The occluding element is preferably retained a second distance away from the light emitting element, but can alternatively be retained against the substrate (e.g., coplanar with or depressed toward the substrate relative to the light emitting elements). The ratio of the second distance to the width of the light aperture of the occluding element is preferably controlled to trim the cone to the desired angle (e.g., 90°, 60°, etc.). However, the second distance can be otherwise selected.

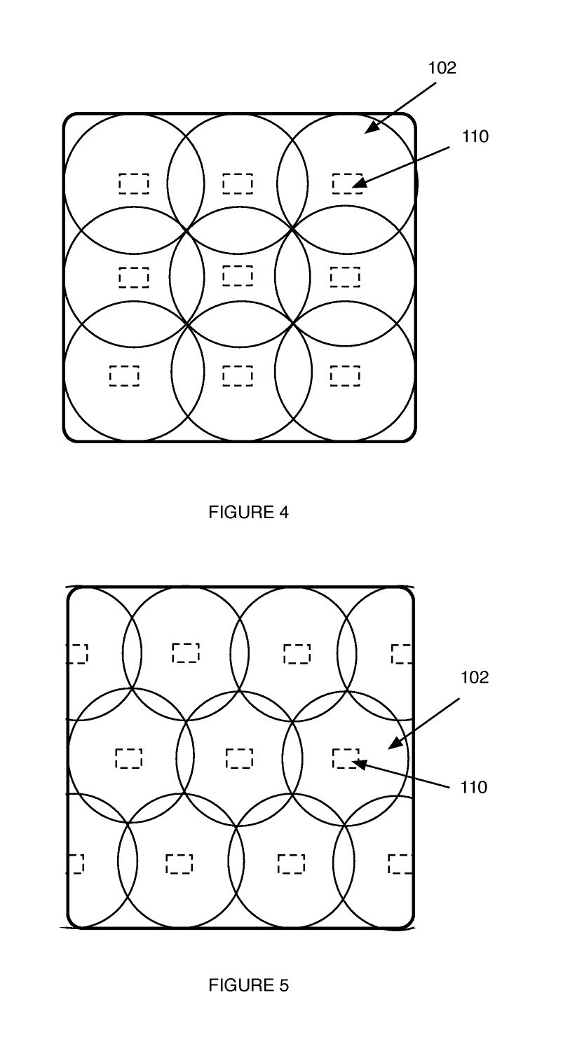

The diffuser 200 of the lighting system functions to diffuse light. As shown in FIG. 6, the diffuser is preferably arranged a diffuser distance 210 (first distance) away from the light emitting arrangement. The diffuser distance is preferably determined based on the diffusion angle of the diffuser. The diffusion angle is preferably the angle at which an incident ray is deflected when transmitted through the diffuser 200, but can alternatively be the angle at which an incident ray is reflected off the diffuser, any other suitable measure of diffusivity. The diffuser distance preferably varies inversely with the diffusion angle. For example, the diffuser distance can be a first distance when the diffusion angle is 60°, and can be a second distance shorter than the first distance when the diffusion angle is 80°. However, the diffuser distance can be determined in any other suitable manner. The diffuser distance is preferably measured at the center of the lighting system (e.g., normal to the light emitting arrangement), but can alternatively be measured at the edge of the lighting system or measured at any other suitable portion of the lighting system. The diffuser distance can additionally or alternatively be dependent upon the spacing distance of the light emitting elements. The ratio of the spacing between adjacent light emitting elements to the diffuser distance is controlled based on the diffusion angle of the diffusion, but can be otherwise controlled. This ratio preferably varies proportionally with the diffusion angle of the diffuser, such that the diffuser distance varies inversely with the diffusion angle, but can vary in any other suitable manner. The ratio can vary linearly, logarithmically, exponentially, parabolically, or vary in any suitable manner with relation to the diffusion angle. For example, with a diffuser having a diffusion angle of 50°, the ratio of the spacing between light emitting elements to the diffuser distance is preferably 2:3. In another example, in a system with a diffuser having a diffusion angle of 30°, the ratio of the spacing between light emitting elements to the diffuser distance is preferably approximately 1:2. However, the ratio can be smaller than 1:2, larger than 2:3, or be any other suitable ratio, dependent upon the diffusion angle of the diffuser.

The diffuser preferably has a diffusion angle of between 20°-60°. More preferably, the diffuser has a diffusion angle of 40°. The diffuser is preferably slightly opaque, such that the diffuser diffuses light. The diffuser is preferably between 10%-90% transparent (e.g., allows 10%-90% of incident light through), but can alternatively be between 30%-70% transparent, or have any other suitable transparency. The diffuser preferably permits 100% light transmission, but can alternatively permit 10%-90% light transmission, between 25-75% light transmission, or permit any other suitable light transmission therethrough. The diffuser preferably scatters 10-90% of the incident light, but can alternatively scatter 30-70% of the incident light, or scatter any other suitable proportion of incident light. The diffuser is preferably white and reflects light across the visible light spectrum, but can alternatively be tinted and reflect light along a subset of the visible light spectrum, or have any other suitable color.

The diffuser preferably has a substantially constant thickness, but can alternatively have a varying thickness. The diffuser can be diverging and be thicker at the edges than in the center or apex, be converging and be thicker at the center or apex than at the edges, or have any other suitable configuration. The diffuser is preferably between 1-3 mm, more preferably between 1.5 mm to 2 mm, but can alternatively have any suitable thickness.

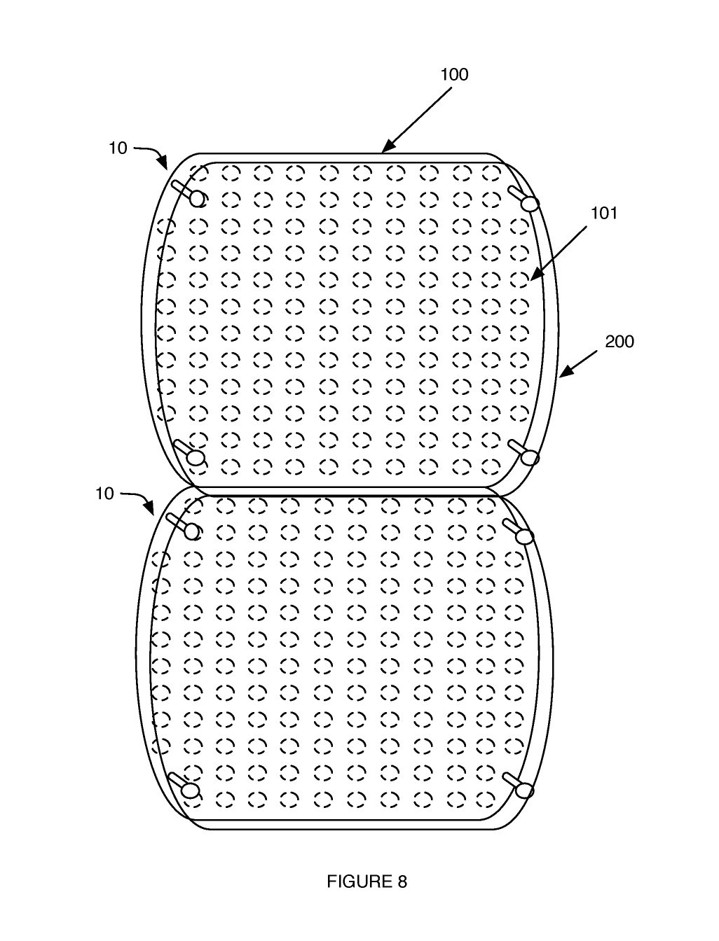

The diffuser is preferably curved, but can alternatively be planar or have any other suitable geometry. The diffuser preferably defines an apex 201 and a set of edges defining the diffuser perimeter. The apex is preferably centered in the diffuser, but can alternatively be offset. The diffuser is preferably arranged with the apex substantially centered relative to the array of light emitting elements, but can alternatively be arranged with the apex offset from the light emitting element array center. The diffuser is preferably concave toward the light emitting arrangement, but can alternatively be convex. The curvature of the diffuser preferably varies proportionally with the diffusion angle of the diffuser. The diffuser is preferably plano-convex (as shown in FIG. 9A), but can alternatively be concavo-convex (as shown in FIG. 9B), plano-concave, convexo-concave, or have any other suitable form factor. The diffuser is preferably a substantially flat piece that is bent during assembly, but can alternatively be manufactured as a curved piece. In one variation of the system, the corners of the diffuser are retained relative to the light emitting assembly.

The diffuser is preferably made from a solid sheet of plastic, but can alternatively be made from cloth, woven plastic, woven metal, or any other suitable material. The diffuser can be laminated, printed, or otherwise applied to a substrate. Examples of diffuser material include Makrolon™ Lumen LC5, Acrylite (0D0002), Fusion Optix™ (e.g., 4040 or 6060), or any other suitable material. The diffuser can be manufactured from a diffusing film coupled along a broad face of an otherwise substantially transparent material, can be manufactured from a thick film (e.g., 60-80 thousandths of an inch), or can be manufactured in any other suitable manner.

The diffuser is preferably retained relative to the light emitting arrangement by adhesive, clips, grooves, screws, standoffs or any other suitable retention mechanism 400. The retention mechanism can additionally function to retain the position of the absorbing mask and/or any other suitable lighting system component relative to the light emitting element. The retention mechanism is preferably mounted to the casing, but can alternatively be mounted to the substrate or any other suitable lighting system component. The retention mechanism can be a standoff that retains the diffuser the first distance from the light emitting element. The retention mechanism can be located at the corners of the lighting system or at the center of the lighting system, but can alternatively be maintained by the casing or by any other suitable mechanism. The retention mechanism is preferably angled relative to a normal vector of the substrate or diffuser broad face, but can alternatively be oriented along the normal vector. The retention mechanism is preferably angled outward (e.g., the acute angle formed by the retention mechanism is proximal the proximal lighting system edge), but can alternatively be angled inward. Retention mechanism angling can be desirable to reduce retention mechanism interference with the emitted light. In one variation of the lighting system, the longitudinal axis of the retention mechanism is angled 45° relative to the first broad face of the substrate (e.g., face of the substrate proximal a light-emitting side of the light emitting element).

The diffuser can additionally include a partially transparent layer that functions to adjust the optical properties of the rendered image. The partially transparent layer is preferably arranged on a broad face of the diffuser distal the light emitting arrangement, but can be arranged on the broad face of the diffuser proximal the light emitting arrangement. The partially transparent layer preferably covers the entirety of the diffuser broad face, but can alternatively cover only a portion of the diffuser broad face. The partially transparent layer can be bonded to the diffuser, stretched over the diffuser, or otherwise coupled to the diffuser. Examples of the partially transparent layer can include silk or paint. The transparent layer can be arranged on the first diffuser broad face proximal the array of light emitting elements, along an edge of the diffuser, or be arranged on the second diffuser broad face distal the array of light emitting elements.

The first and/or second diffuser broad face can additionally include texturing, films, treatment, or any other suitable feature that functions to adjust the optical properties of the rendered image. However, the first and/or second diffuser broad face can be flat, polished, untreated, or have any other suitable property. In one variation, the first diffuser broad face includes texturing or a coating that reduces reflection off the diffuser from the light emitting elements.

The absorbing mask 300 of the system functions to absorb the light reflected back from the diffuser. The absorbing mask preferably absorbs more of the reflected light than the substrate, but can alternatively absorb less. The absorbing mask preferably absorbs most of the reflected light (e.g., 80% or more of the reflected light), but can alternatively absorb more or less than 80% of the reflected light. The inclusion of this absorbing mask is taught against by those skilled in the lighting and monitor arts, which both seek to increase the light efficiency by reflecting the reflected light back at the diffuser. Instead, this absorbing mask seeks to minimize the amount of light reflected back toward the diffuser. By absorbing the majority of the reflected light, the absorbing mask can increase the effective resolution and contrast of the lighting system, thereby decreasing the light emitting element count. The absorbing mask can additionally function as the shaping mask 350, as discussed below.

The absorbing mask is preferably black, and absorbs light along the entirety of the visible spectrum, but can alternatively be gray or any other suitable color. The absorbing mask can additionally absorb any other suitable form of electromagnetic radiation. The absorbing mask color can be selected based on the spectrum of light emitted by the light emitting elements, wherein the absorbing mask preferably absorbs the emitted spectra. The absorbing mask preferably has a diffuse reflection (e.g., deflects incident light away from the angle of reflection), such that the absorbing mask appears matte or flat, but can alternatively have specular reflection, such that the absorbing mask appears glossy. The absorbing mask preferably absorbs and/or diffuses light along both the first and second opposing absorbing mask broad face (e.g., broad face proximal and distal the light emitting elements, respectively), but can alternatively absorb and/or diffuse light along only the first or second absorbing mask broad face. However, the absorbing mask can reflect light in any other suitable manner.

The absorbing mask is preferably arranged between the light emitting arrangement and the diffuser. The absorbing mask is preferably arranged proximal the light emitting arrangement and distal the diffuser. The absorbing mask can be the substrate behind the light emitting elements, a layer overlaid over the substrate, or any other suitable layer. The absorbing mask is preferably made of painted metal, but can alternatively be made of paper, cloth, felt, or any other suitable material. The absorbing mask is preferably substantially planar, but can alternatively be curved, wavy, or have any other suitable configuration. The absorbing mask can additionally include surface features that can promote light absorption. The absorbing mask can include divots, bumps, or any other suitable surface features.

The absorbing mask preferably includes a light emitting element interface. The light emitting element interface 310 is preferably the portion of the absorbing mask that interfaces with the light emitting element. The light emitting element interface is preferably a light transmitting window, wherein the light emitting element either fits through the light transmitting window or shines light through the light transmitting window. The light transmitting window is preferably transparent, but can alternatively be translucent. The light transmitting window can be a through-hole in the absorbing mask, a through-hole including a translucent film disposed across the aperture, an array of microscopic holes, a non-tinted portion of the absorbing mask, or defined any suitable manner. The translucent film can function to adjust the optical properties of the rendered image, uncovered, or include any other suitable component. The light transmitting window can be rectangular (e.g., square), circular, ovular, triangular, a rounded square (e.g., wherein the edges are convex, away from the window center), a concave square (e.g., wherein the edges are concave toward the center), or have any other suitable shape. The light transmitting window can have the same dimensions at the first broad face of the absorbing mask and second broad face of the absorbing mask, but can alternatively have as first and second different dimension at the first and second broad faces, respectively. In the latter variation, the light transmitting window preferably has a smooth transition between the first and second dimensions, but can alternatively have a stepped transition or have any other suitable transition between the first and second dimensions.

Alternatively, the light emitting element interface can be a divot, wherein the light emitting element rests within or shines light through the apex of the divot. Alternatively, the light emitting element interface can be a protrusion, wherein the light emitting element rests within or shines light through the apex of the protrusion. However, the light emitting element interface can be any other suitable interface between the absorbing mask and the light emitting element.

The lighting system can additionally include a shaping mask 350, which functions to shape the light emitting element projections on the diffuser. In a first variation, the absorbing mask functions as the shaping mask (as shown in FIG. 7). In another variation, the shaping mask is a separate element. The shaping mask is preferably arranged between the light emitting arrangement and the diffuser, more preferably between the absorbing mask and the light emitting arrangement but alternatively in any suitable position. The shaping mask or element functioning as the shaping mask can be arranged proximal the diffuser and distal the light emitting arrangement (e.g., 1 cm away from the diffuser) such that the projection of the light emitting elements on the diffuser have soft edges (a penumbra) that overlap with at least one, preferably all, of the neighboring light emitting element projections. In this variation, the shaping mask can have an aperture pattern that directly corresponds to the array pattern of light emitting elements on the light emitting arrangement, but can alternatively have an aperture pattern that does not correspond with the light emitting element array pattern, such that the shaping mask interferes with all or a portion of the light projected from the light emitting elements. However, the shaping mask can be arranged at any other suitable location. The shaping mask preferably has substantially the same dimensions (or substantially the same broad area) as the light emitting arrangement, but can alternatively be larger or smaller. The shaping mask preferably has light apertures 351 extending through the shaping mask thickness. The light apertures are preferably distributed in a pattern that substantially matches the light emitting element distribution on the light emitting arrangement, but can alternatively be distributed in a pattern that is offset from the light emitting element distribution, in a random pattern, or distributed in any suitable arrangement. The light apertures can be through-holes, prisms, light filters (e.g., polarizing filters, color filters, etc.), or any other suitable aperture. The light apertures are preferably geometric shapes, but can alternatively be amorphous or have any suitable shape. Light aperture shape examples include circles, hexagons, rectangles, stars, star shapes, waves, or any other suitable shape. Each light aperture can correspond (e.g., align with) one or more light emitting elements. The shaping mask can be the absorbing mask, wherein the light apertures can be the light transmitting windows, or the shaping mask can be a secondary mask. The shaping mask can be arranged between the absorbing mask and the diffuser, between the substrate and the absorbing mask, or in any other suitable configuration.

The lighting system preferably additionally includes a casing 500, which functions to mechanically protect the electronics of the lighting system. The casing preferably extends along the broad face of the light emitting arrangement distal the diffuser. The casing can additionally wrap around the sides of the lighting system, and can extend to the edges of the diffuser. The casing and substrate of the light emitting arrangement preferably cooperatively encapsulate the wiring for each light emitting element, the power source (e.g., power converter), the processor, any on-board memory, or any other suitable electronic component of the lighting system. The casing preferably additionally supports the light emitting arrangement and the diffuser, and preferably retains the diffuser distance between the light emitting arrangement and the diffuser. The casing interior is preferably dark, more preferably the same color as the matting. However, the casing interior can be any other suitable color. The casing interior can be lined with a light absorbing liner. The casing is preferably thermally insulative, but can alternatively be thermally conductive. Thermally insulative casings can be used in the lighting system due to the use of low-current, relatively heat-tolerant LEDs, spaced a threshold distance apart (e.g., 1 mm apart, 5 mm apart, 10 mm apart, 17 mm apart, etc.). The inventors have discovered that these properties can be leveraged in a lighting system, such that thermally insulative casing material can be used, in addition to thermally conductive casing material. The casing is preferably CNC-cut bamboo, metal, or wood, but can alternatively be cork, rubber, wool, organic compounds, metal, plastic, or any other suitable material. The casing material is preferably porous or includes through-holes (e.g., micro-holes) to promote cooling, but can alternatively be substantially solid. The system can additionally include an EMI shield or layer arranged over the electronic components. In one variation, the absorbing mask can function as the EMI shield.

The lighting system can additionally include one or more sensors 60o that function to take measurements of the ambient environment. The lighting system preferably adjusts one or more operation parameters based on the sensor measurements. The operation parameters can include the light wavelength, intensity, saturation, brightness, or any other suitable light parameter. The operation parameters can include a speed of light pattern play, the selected light pattern, or any other suitable operation parameter. In one example, the light can be tinted warmer (e.g. by controlling the light emitting elements to increase intensity, brightness, saturation, or excitation purity of red light) in response to the system temperature exceeding a threshold temperature, as determined from a temperature sensor or current sensor. In another example, the intensity of light emitted can be changed as a direct function of the ambient light intensity. In another example, the speed of light pattern play can be adjusted as a function of the ambient light intensity or music beat. Sensors that can be included include a light sensor, a camera, a temperature sensor, a transducer (e.g., microphone), humidity sensor, acoustic sensor, accelerometer, gyroscope, gesture sensor, touch sensor (e.g., a capacitive touch sensor, a knob, etc.), infrared sensor, current sensor, or any other suitable sensor. The sensors can be located along an edge of the lighting system, in the center of the lighting system, on the substrate, on the diffuser, on the absorbing mask, or at any other suitable location of the lighting system.

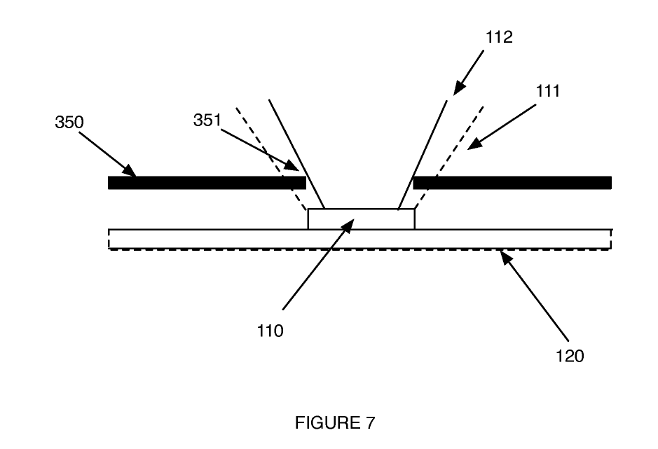

As shown in FIG. 6, the lighting system can additionally include one or more coupling mechanisms 600 that permit multiple lighting systems to be mounted together, as shown in FIG. 8. Such coupling mechanisms can include clips, tongue-and-groove interfaces, or any other suitable coupling mechanism. The lighting system can additionally include power sharing and/or data sharing mechanisms that permit the lighting system to share power and/or data with adjacent lighting systems. The power sharing and/or data sharing mechanism can be integrated with the coupling mechanism, or can be separate.

As shown in FIG. 6, the lighting system can additionally include a data input 700 that functions to receive an input from a user. The lighting system operation is preferably controlled based on the data input. The data input can be a keyboard, a pointing device, a touch sensor (e.g., a resistive or capacitive touch sensor), or any other suitable data input. In one variation of the lighting system, the retention mechanisms function as the data inputs, wherein the retention mechanisms are electrically conductive and operatively couple to a lighting system controller 800. The electrically conductive retention mechanisms can additionally function to ground the diffuser. This can be desirable when the diffuser material has an inherent electrostatic charge, which can attract dust, dirt, or other particulates. Grounding the diffuser will reduce the electrostatic charge, thereby reducing the amount of particulate matter attracted to the diffuser. In another variation of the lighting system, the data input can be an electrically conductive strip along an edge of the diffuser, wherein different points along the strip length can be mapped to different lamp operation modes. However, any other suitable data input can be used.

The lighting system preferably additionally includes a controller that functions to control lighting system operation. The controller can additionally function to control operation of adjacent lighting systems. The controller is preferably connected to a storage mechanism, such as a server or mobile device, that stores the lighting patterns. The connection can be wired or wireless. The storage mechanism can be remote or collocated with the controller. The controller preferably receives the lighting pattern, assigns portions of the lighting pattern to individual pixels (e.g., light emitting element or set of light emitting elements), and sends the lighting pattern portions to the individual pixels. The controller can additionally control light emitting element operation based on the sensor measurements.

The lighting system can additionally include a power connection. The power connection can be a wall outlet, a USB outlet, or any other suitable power connection. Alternatively, the lighting system can include a battery, such as a secondary (e.g., rechargeable) battery or any other suitable battery. The lighting system can additionally include a charger that functions to charge the battery. The charger can be a wired charger, or can be a wireless charger (e.g., inductive charger). However, the lighting system can include any other suitable power transmission mechanism.

The lighting system preferably includes a power inlet, a power outlet, a data inlet, and a data outlet. Multiple lighting systems are preferably capable of being connected together in parallel, in series (e.g., by daisy chaining the lighting systems), or in any other suitable configuration. The positions of the multiple lighting systems are preferably manually mapped and the location stored on the respective lighting system, but can alternatively be automatically determined.

The method of manufacturing the lighting system preferably includes assembling the light emitting elements to the substrate to form the light emitting arrangement, coupling the light emitting arrangement with the casing, coupling the absorbing mask to the casing such that the light emitting arrangement is between the absorbing mask and the casing, and coupling the diffuser to the light emitting arrangement. However, the absorbing mask can be coupled to the light emitting arrangement, to the diffuser, or to any other suitable light system component. The light emitting elements can be wave soldered, dip-soldered, hand-soldered, reflow soldered, or otherwise assembled to the substrate. The light emitting elements are preferably arranged on a single broad face of the substrate, but can alternatively be arranged on both sides. Applying the absorbing mask to the light emitting arrangement preferably includes aligning the light emitting elements with the light emitting element interfaces of the absorbing mask and coupling the absorbing mask to the light emitting arrangement. Coupling the absorbing mask to the light emitting arrangement can include adhering the absorbing mask to the light emitting arrangement, fitting the light emitting elements through the light emitting element interfaces, coupling the absorbing mask to the light emitting arrangement as the light emitting arrangement is coupled to the casing (e.g., with one or more long screws), or otherwise coupled to the light emitting arrangement. Coupling the light emitting arrangement to the casing can include clipping, screwing, adhering, or otherwise coupling the light emitting arrangement to the casing. In one example, coupling the light emitting arrangement to the casing includes snapping the substrate into a groove in the casing. Coupling the diffuser to the light emitting arrangement can include mounting the diffuser to diffuser distance retainers, wherein the diffuser distance retainers can be arranged at the lighting system corners, periodically along the lighting system edges, along the active face of the lighting system, or in any other suitable position. The diffuser distance retainer can be a piece that couples to the light emitting arrangement or the casing, or can be the casing itself. Mounting a diffuser to a diffuser distance retainer can include clipping, adhering, screwing, or otherwise coupling the diffuser into the diffuser distance retainer. Coupling the diffuser to the light emitting arrangement can additionally include bending the diffuser prior to coupling, wherein the concave side of the diffuser is preferably arranged proximal the light emitting arrangement. The diffuser can be plastically deformed or elastically deformed. The diffuser can be heat-formed, manufactured as a curved piece, bent during installation, or bent in any other suitable manner. The lighting system is preferably assembled in a top-down manner, but can alternatively be assembled in any other suitable manner.

In one example of the lighting system, the lighting system is 1 ft×1 ft. the light emitting arrangement is preferably formed from a plurality of RGB LEDs (light emitting diodes), arranged in a regular rectilinear grid. The light emitting arrangement can include a 16 by 16 grid of LEDs, each spaced approximately 17 mm apart, a 12 by 12 grid of LEDs spaced approximately 21 mm apart, or any other suitable arrangement of LEDs spaced any suitable distance apart. However, each RGB LED can include a white and/or deep red LED that is clustered with the RGB LED. The inclusion of the white and/or deep red LEDs can function to fill in the gaps of the visual spectrum left by the RGB LEDs, which can function to improve the reflected light quality. The lighting system preferably additionally includes a dark absorbing mask, more preferably a black matting. The absorbing mask is preferably arranged along the broad face of the substrate supporting the LEDs. More preferably, the matting is arranged behind the LEDs. The light emitting element interface preferably includes a plurality of holes, arranged in a pattern that substantially matches the light emitting element arrangement. The diffuser is preferably arranged proximal the matting, such that the matting is disposed between the diffuser and the light emitting arrangement. The diffuser is preferably curved, such that the diffuser center is further from the light emitting arrangement than the diffuser edges. In one variation of the system, the diffuser is a 1.5 mm piece of Makrolon Lumen LC5, with a diffusion angle of 50 degrees, that is arranged 33 mm away from the LEDs. In another variation of the system, the diffuser is a 1.5 mm-2.0 mm piece of printed acrylic, with a diffusion angle of 40 degrees, that is arranged 33.5 mm away from the LEDs and bent with a 1.5 mm difference between the apex and the edge. In another variation of the system, the diffuser is a 1.5 mm-2.0 mm piece of laminated acrylic, with a diffusion angle of 60 degrees, that is arranged 33.5 mm away from the LEDs and bent with a 1.5 mm difference between the apex and the edge. In another variation of the system, the diffuser is a 3.0 mm piece of acrylic, with a diffusion angle of approximately 30 degrees, that is arranged 43.5 mm away from the LEDs. In another variation of the system, the diffuser is a 2.0 mm piece of acrylic, with a diffusion angle of approximately 20 degrees, that is arranged 56.0 mm away from the LEDs. The diffuser can additionally include a partially transparent layer distal the matting.

In another example, the lighting system includes a light emitting arrangement, a first and a second absorbing mask, and a first and a second diffuser. The light emitting arrangement preferably includes a light emitting elements along two faces. More preferably, the light emitting arrangement includes light emitting elements along a first and a second broad face. The first broad face preferably opposes the second broad face, thereby permitting light to be emitted in opposing directions. However, the first broad face can be normal to the second broad face or be otherwise arranged relative to the second broad face. The light emitting arrangement is preferably formed from a singular PCB with light emitting elements (e.g., LEDs) on either broad face, but can alternatively be formed from two PCBs or formed in any other suitable manner. The first and second absorbing mask and diffuser are preferably arranged proximal the first and second broad face of the light emitting arrangement, respectively, with the respective absorbing mask proximal the light emitting elements and the respective diffuser distal the light emitting elements. The light emitting elements and/or the distribution of the light emitting elements on the first and second broad faces can be substantially identical or be different. The first and second absorbing mask can be substantially identical or be different. The first and second diffuser can be substantially identical or be different.

As a person skilled in the art will recognize from the previous detailed description and from the figures and claims, modifications and changes can be made to the preferred embodiments of the invention without departing from the scope of this invention defined in the following claims.

We claim:

1. A lighting assembly comprising:
an array of light emitting diodes mounted along a first face of a substrate;
a curved translucent diffuser retained proximal the first face of the substrate, offset from the substrate a first distance;
a light-absorbing mask comprising an array of light-transparent windows, the light-absorbing mask arranged between the substrate and the diffuser and retained offset from the first face of the substrate a second distance, with the light-transparent windows substantially aligned with the array of light emitting diodes; and
a thermally insulative casing mounted to a second face of the substrate opposing the first face of the substrate.

2. The lighting system of claim 1, wherein the light absorbing mask reduces an emission cone of each light emitting element to a 90 degree cone.

3. The lighting system of claim 1, wherein the light-absorbing mask is configured to absorb light reflected by the translucent diffuser.

4. A lighting assembly comprising:
an array of light emitting elements mounted to a first face of a substrate;
a translucent diffuser arranged offset the first face of the substrate a first distance; and
a light-absorbing mask comprising an array of light-transparent windows, arranged between the diffuser and the first face of the substrate, with each of the light-transparent windows aligned with a light emitting element of the array.

5. The lighting system of claim 4, wherein the ratio of spacing between adjacent light emitting elements and the first distance is at least 1:2.

6. The lighting system of claim 4, wherein the diffuser is curved and comprises an apex.

7. The lighting system of claim 6, wherein the apex is substantially centered relative to the array of light emitting elements.

8. The lighting system of claim 6, wherein the diffuser is plano-convex.

9. The lighting system of claim 4, wherein the diffuser has a diffusion angle of 90 degrees or less.

10. The lighting system of claim 4, further comprising standoffs statically retaining the diffuser to the substrate.

11. The lighting system of claim 10, wherein the standoffs comprise conductive standoffs electrically connected to a controller operatively connected to the array of light emitting diodes.

12. The lighting system of claim 11, wherein the standoffs are electrically connected to the diffuser, and the diffuser comprises acrylic.

13. The lighting system of claim 12, wherein the standoffs are angled relative to a normal vector of the substrate toward a proximal edge of the substrate.

14. The lighting system of claim 4, wherein the light-absorbing mask is retained offset the first face of the substrate a second distance with each light transmitting window substantially aligned with a light emitting element.

15. The lighting system of claim 14, wherein each light transmitting window partially occludes a portion of an emission cone emitted from a respective light emitting element.

16. The lighting system of claim 15, wherein the light-transmitting windows comprise rounded square profiles.

17. The lighting system of claim 4, further comprising a casing mounted to a second face of the substrate opposing the first face of the substrate.

18. The lighting system of claim 17, wherein the casing comprises a thermally insulative material.

19. The lighting system of claim 18, wherein the casing comprises cork.

20. The lighting system of claim 19, wherein the light emitting elements comprise red light emitting diodes and the lighting system further comprises a controller configured to operate the red light emitting diodes in response to a system temperature exceeding a threshold temperature.
